(19) United States
(12) Patent Application Publication
(10) Pub. No.: US 2011/0253725 A1
(43) Pub. Date: Oct. 20, 2011

(54) MULTI-PORT BEVERAGE AND FOOD CONTAINERS

(76) Inventor: William Killian, Abington, PA (US)

(21) Appl. No.: 13/026,605

(22) Filed: Feb. 14, 2011

Related U.S. Application Data
(60) Provisional application No. 61/304,419, filed on Feb. 13, 2010.

(51) Int. Cl. B65D 25/04; B23P 19/00

(52) U.S. Cl. 220/524; 29/428

(57) ABSTRACT

Provided are beverage and food containers comprising two or more compartments, each compartment divided from the others so that the beverage or food in one compartment does not contact the beverage or food in any other compartment. Each compartment has its own spout or opening, and a cap for sealing the spout or opening. Also provided are caps shaped and configured to represent various different entities, such as sports team insignia, sports team mascot, sports team icon, a fictional character, animal, etc.

### CROSS REFERENCE TO RELATED APPLICATIONS

This application claims priority from U.S. Provisional Patent Application No. 61/304,419 filed on Feb. 13, 2010 by Killian titled “MULTI-PORT BEVERAGE CONTAINERS,” which is incorporated herein by reference in its entirety.

### FIELD OF THE INVENTION

This invention relates to beverage and food containers having multiple sections and pour spouts for holding multiple beverages or foods.

### BACKGROUND OF THE INVENTION

Generally, modern beverage containers come is various forms and sizes, and are made of various materials. For example, soda containers are typically made of plastic and formed using a blow mold process, having a single pouring spout, intended for holding a single beverage. Likewise, milk containers are also typically either made of plastic or may be made of a cardboard material coated with a water-resistant repellant layer to prevent leakage, having a single pouring spout, and also intended for holding a single beverage.

These containers have several advantages over prior containers made of glass and/or metal, particularly in larger sizes, e.g., greater than 12 ounces. For example, they can be produced very inexpensively, and therefore can be disposable.

However, since each container can hold only one beverage, there is a disadvantage in that in a group environment—e.g., a family or other small group—oftentimes individuals will desire different beverages. Particularly with respect to the larger size containers, greater than 12 ounces, having to purchase and store multiple beverage containers for multiple individuals is expensive and requires a large storage area.

Thus, there is a need for beverage and food containers for holding two or more different beverages or foods, each accessible via a separate opening or spout.

### SUMMARY OF THE INVENTION

An aspect of the present invention provides a beverage or food container comprising two or more compartments, each compartment divided from the others so that the contents of one compartment does not contact the contents of any other compartment, with each compartment having its own spout.

In a further aspect of the invention, two or more caps are provided, each cap configured and positioned for attachment to one of the spouts, thereby removably sealing the compartment associated with the spout to which the cap is attached. It is also provided for the caps and spouts to be threaded so that each cap can be mated onto one of the spouts by threading to removably seal the compartment associated with the spout.

Another aspect of the present invention provides that each cap is shaped to represent a different particular identifiable entity, including but not limited to a sports team insignia, a sports team mascot, a sports team icon, a fictional character, or an animal.

Another aspect of the present invention provides for the inventive container to be made of plastic or cardboard, and to be shaped like any of various well-known containers, such as, but not limited to a plastic two-liter soda bottle, a plastic one-gallon or half-gallon milk container, or a cardboard half-gallon milk container.

Another aspect of the present invention provides that the container have two compartments.

### BRIEF DESCRIPTION OF THE DRAWINGS

FIG. 1 depicts a multi-port beverage container, in accordance with an embodiment of the present invention;

FIG. 2 depicts a multi-port beverage container, in accordance with an embodiment of the present invention;

FIG. 3 depicts a multi-port beverage container, in accordance with an embodiment of the present invention;

FIG. 4 depicts a multiport food container, in accordance with an embodiment of the present invention;

FIG. 5 is a photograph of a beverage container, in accordance with an embodiment of the present invention;

FIG. 6 is a photograph of a beverage container, in accordance with an embodiment of the present invention;

FIG. 7 is a photograph of a beverage container, in accordance with an embodiment of the present invention;

FIG. 8 is a photograph of a beverage container, in accordance with an embodiment of the present invention;

FIG. 9 is a photograph of a beverage container, in accordance with an embodiment of the present invention;

FIG. 10 is a photograph of a beverage container, in accordance with an embodiment of the present invention;

FIG. 11 is a photograph of a beverage container and sample caps having a sports theme, in accordance with an embodiment of the present invention;

FIG. 12 is a photograph of a beverage container and sample caps having a sports theme, in accordance with an embodiment of the present invention;

FIG. 13 is a photograph of a beverage container and sample caps having a sports theme, in accordance with an embodiment of the present invention;

FIG. 14 is a photograph of a beverage container, in accordance with an embodiment of the present invention;

FIG. 15 is a photograph of a beverage container and sample caps having a sports theme, in accordance with an embodiment of the present invention;

FIG. 16 is a photograph of a beverage container and sample caps having a sports theme, in accordance with an embodiment of the present invention; and,

FIG. 17 is a photograph of a beverage container, in accordance with an embodiment of the present invention.

### DETAILED DESCRIPTION

The present invention is drawn to multiport beverage and food containers.

The present invention advantageously provides a beverage or food container designed to hold at least two separate beverages or foods. The inside of the container is divided into at least two sections via a wall. One beverage or food is held in one section, and another beverage or food is held in the other section. Each section includes its own spout or opening, so that each beverage or food can be consumed without being contaminated by the other beverage or food.

The present invention also advantageously provides for a beverage or food container comprising two or more compartments, each compartment divided from the others so that the contents of one compartment does not contact the contents of any other compartment, with each compartment having its own spout.

The present invention also advantageously provides for two or more caps, each cap configured and positioned for attachment to one of the spouts, thereby removably sealing the compartment associated with the spout to which the cap is attached. It is also advantageously provided for the caps and spouts to be threaded so that each cap can be mated onto one of the spouts by threading to removably seal the compartment associated with the spout.

The present invention also advantageously provides that each cap is shaped to represent a different particular identifiable entity, including but not limited to a sports team insignia, a sports team mascot, a sports team icon, a fictional character, or an animal.

The present invention also provides container to be made of plastic or cardboard, and to be shaped like any of various well-known containers, such as, but not limited to a plastic two-liter soda bottle, a plastic one-gallon or half-gallon milk container, or a cardboard half-gallon milk container.

The present invention also advantageously provides a method for making the containers.

The present invention also advantageously provides for sustaining the freshness of the beverages or foods in the container. Because the contents of the container are separated by a wall, when one port is opened to dispense the contents on one side of the container, the contents in the other section of the container remains sealed inside of its section. Thus, even if one side is open, the contents on the other side of the container remains closed, thus allowing it to stay fresh.

An embodiment of the invention includes a plastic beverage container shaped like a two liter soda bottle, where the inside of the container is divided into two separate sections, each section having its own spout, so that the container as a whole includes two spouts. In use, the two sections may hold different beverages. For example, one section can hold one type of soda, and the other section can hold a different type of soda; e.g., regular soda/diet soda; one brand of soda/a second brand of soda. The bottle would preferably be molded as a single unit having two separate sections, or by any other known method.

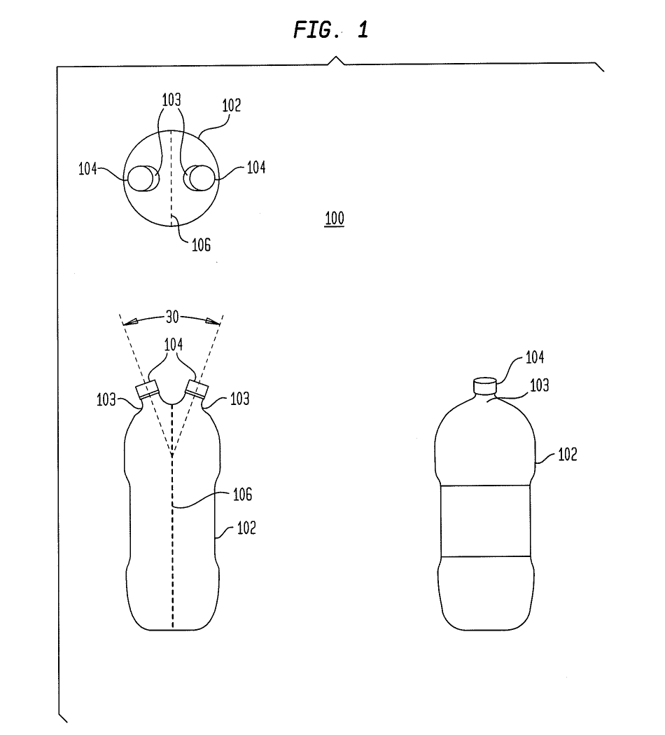

FIG. 1 depicts an exemplary multiport beverage container shaped like a contemporary 2-liter soda bottle 100. In an embodiment of the invention, the body of the container 102 may be formed from plastic using a blow mould process. Conventional blow mould processes may be employed to produce the present invention, as it is understood that the required abilities are within the skill set of those having ordinary skill in the art of blow moulding of plastics.

Spouts 103 are also provided for pouring the beverages contained within the container. In an embodiment of the invention, the spouts are provide with threads on their external surface (not visible in FIG. 1), for removably-sealing caps 104, which are likewise provided with matching threads on their internal surface (also not visible).

Other alternative means of sealing the containers are also envisioned, such as, but limited to use of foil seals instead of or in addition to the caps 104.

In an embodiment of the invention, the interior of the container is divided into two sections by a wall 106, which extends for the entire length and height of the interior and effectively isolates the beverages in each section from the other section. In other embodiments of the invention having more than two sections, not depicted, it is understood that more than one wall 106 is needed to keep the beverage in the different sections from mixing.

The bottle 100 with its wall 106 may be formed by any of several methods, including but not limited to making two half-blown moulds and fusing the two sections together, such as by use of an adhesive or sonic welding, or the like.

Also in an embodiment of the invention, the two spouts 103 are set at an angle 110 from each other, in order to facilitate pouring of a beverage from one of the containers. Although the angle 110 of 30 degrees is depicted in FIG. 1, it is understood that any angle which improves the ease of pouring may be used.

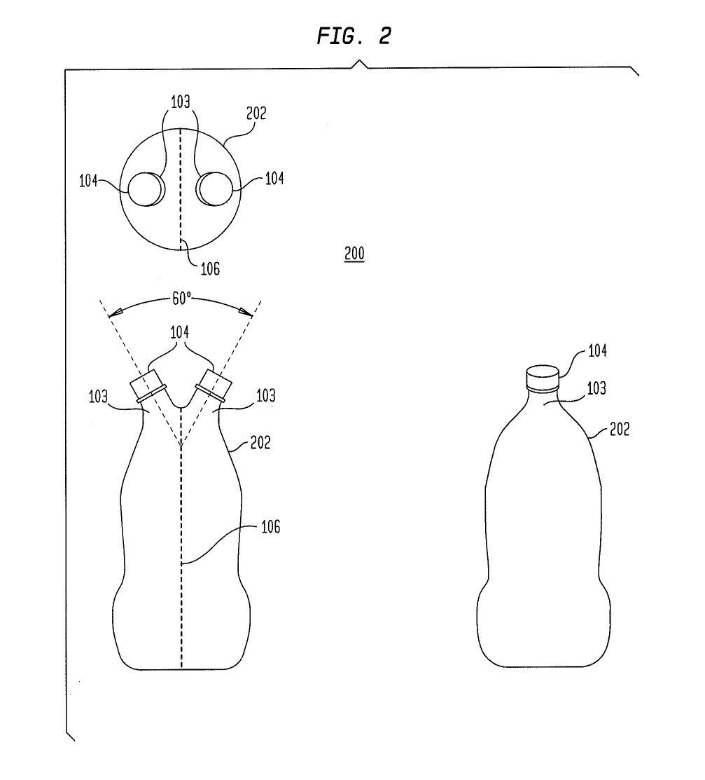

FIG. 2 is another exemplary multiport beverage container shaped like a contemporary 2-liter soda bottle 200. In an embodiment of the invention, the body of the bottle 202 is not limited to any particular shape. Indeed, there are many deviations in the shape of 2-liter soda bottles currently being used.

Also, the embodiment of the invention shown in FIG. 2 has it's two spouts 103 set at a different angle 210—60 degrees. Indeed, any usable angle 210 is contemplated.

In various embodiments, the invention is not limited to plastic containers. For example, cardboard type beverage containers such as those used with orange juice and milk can also be used. For example, a cardboard type beverage container could include two separate sections, one containing iced tea, another may contain a fruit drink. A large number of possible combinations of beverages are envisioned.

Another embodiment of this invention includes a plastic beverage container shaped like a gallon milk container, where the inside of the container is divided into two separate sections, each section having its own spout, so that the container as a whole includes two spouts. In an exemplary usage, one section may hold one type of milk, such as whole milk, while the other section holds a different type of milk, such as 2% milk.

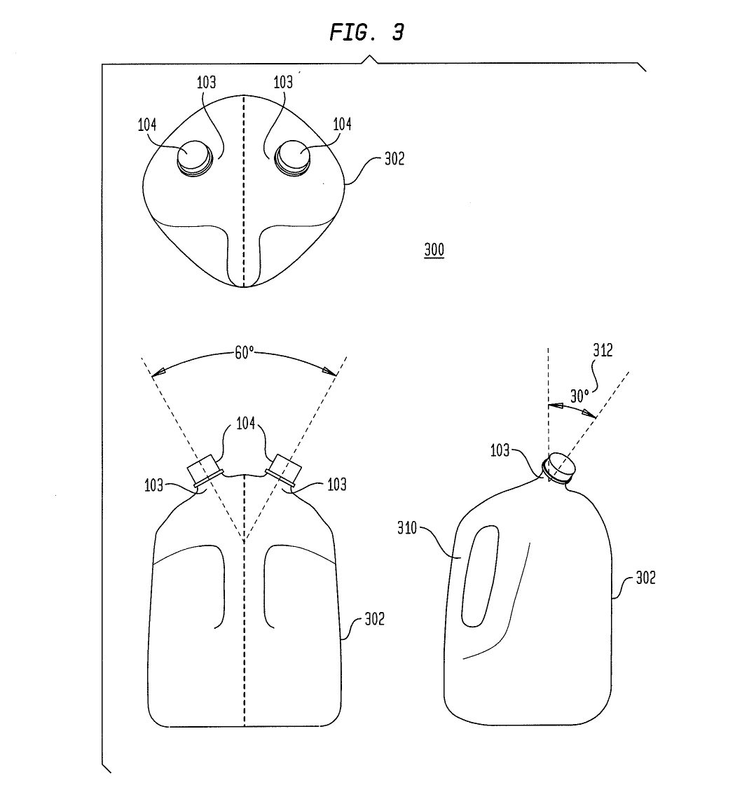

FIG. 3 is an exemplary plastic milk-style container 300. In an embodiment of the invention, a container 100 is provided having the general body 302 shape of a plastic one-gallon milk container, including a handle 310. The spouts 103 are set at an angle 312 from the vertical centerline, in this view, 30 degrees, for ease of pouring. It is again noted that any spout angle 312 that allows fro easy pouring would suffice. Also, while the depiction in FIG. 3 is of a one-gallon container 300, it is understood that a similar container having a different capacity is also envisioned, such as, but not exclusively, half-gallon, one liter, or pint containers, and the like.

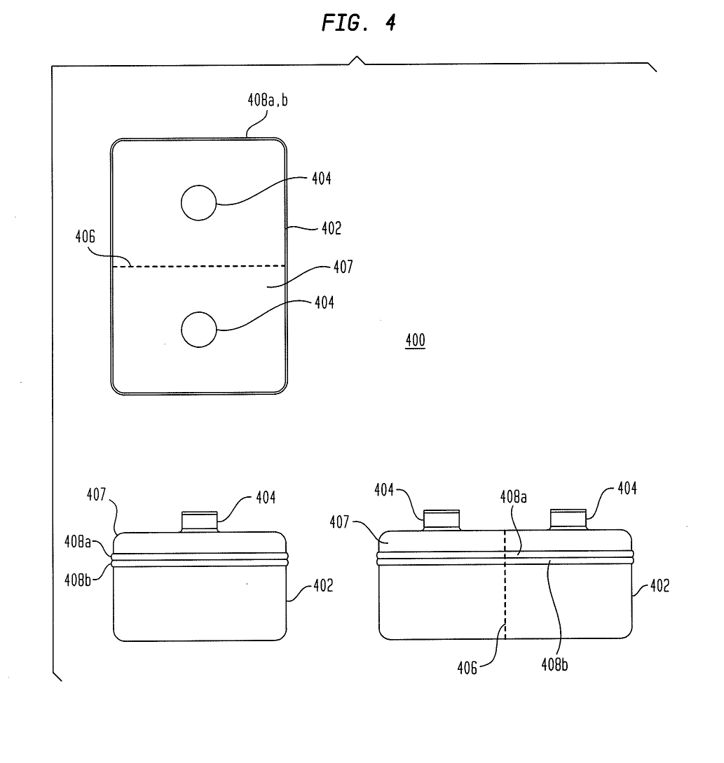

FIG. 4 is an exemplary food container 400. In another embodiment of the invention, a food container 400 is envisioned. A food container would be made using a blow mould process, more particularly an injection mould process, and would preferably be comprised of a stronger and thicker plastic than the beverage containers of the present invention.

In an embodiment of the invention, the food container 400 includes a body 402. As depicted in FIG. 4, the body 402 may might be in the general shape of a rectangular block. Alternatively, other general overall shapes are also envisioned, such as, but not limited to a circular block, a triangular block, or the like.

The body is bisected by an interior wall 406 which serves to divide the container 400 into two sections. It is understood that embodiments of the invention having more than two sections are also envisioned, and that these embodiments would necessitate additional interior dividing walls.

In one embodiment of the invention, the container 400 has a lid 407 which can be opened and closed along a re-sealable seam 408a, 408b, and is useful for loading food product into the container 400. Alternative embodiments of the container 400 are envisioned which are a single unit without the lid 407 or seals 408a, 408b.

In an embodiment of the invention, caps 404 are also provided, which are removably attachable to lips or spouts providing openings into each section of the container 400, not visible in FIG. 4. These caps 40 and openings are preferably wider than the spouts or openings of the above beverage container embodiments to allow a user to insert utensils and extract the food contained therein.

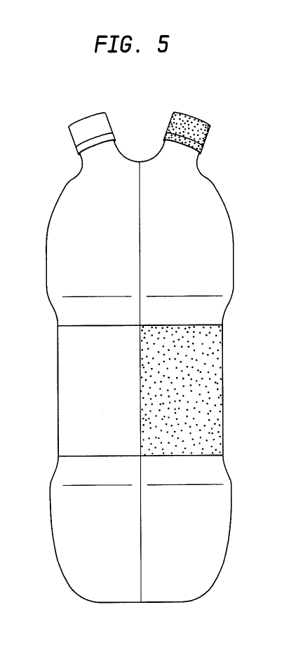

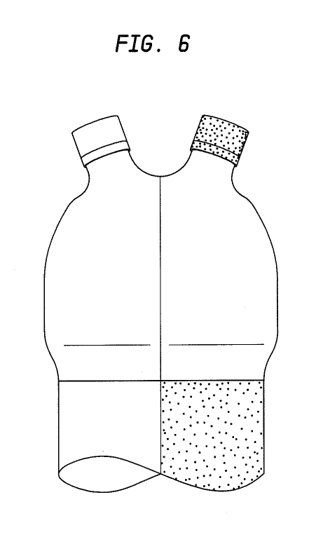

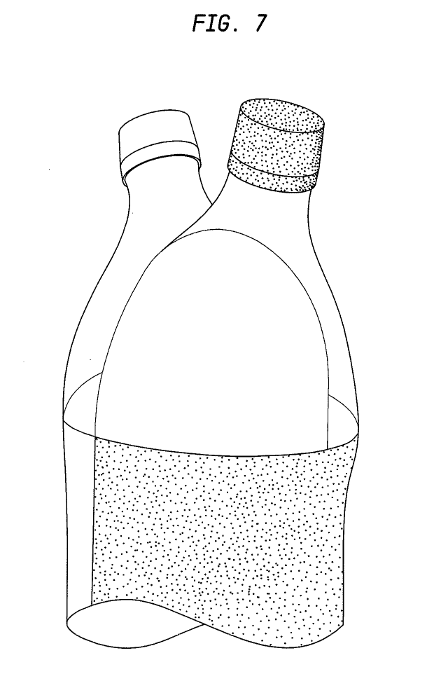

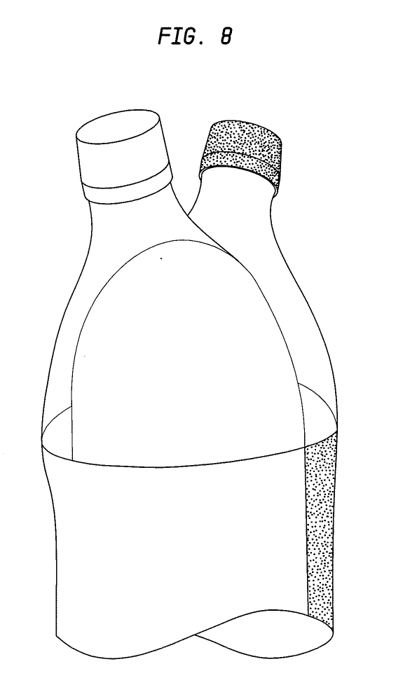

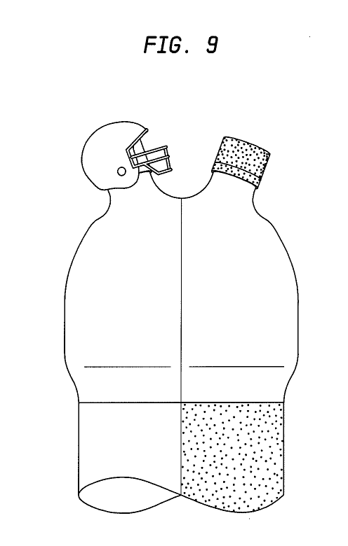

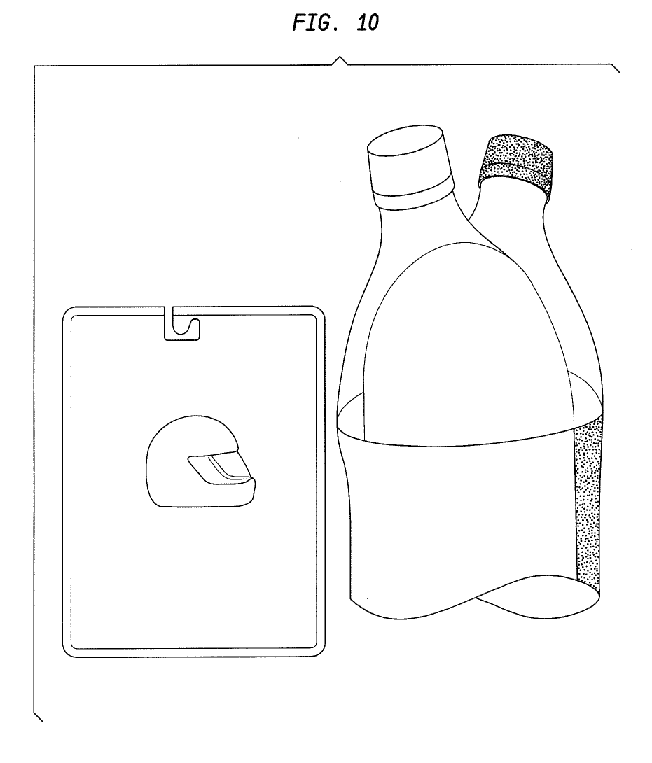

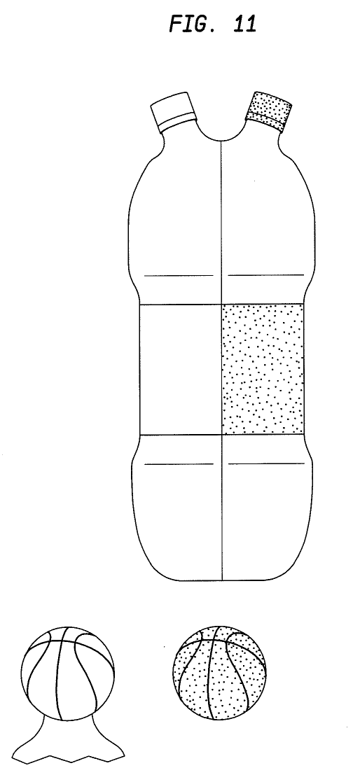

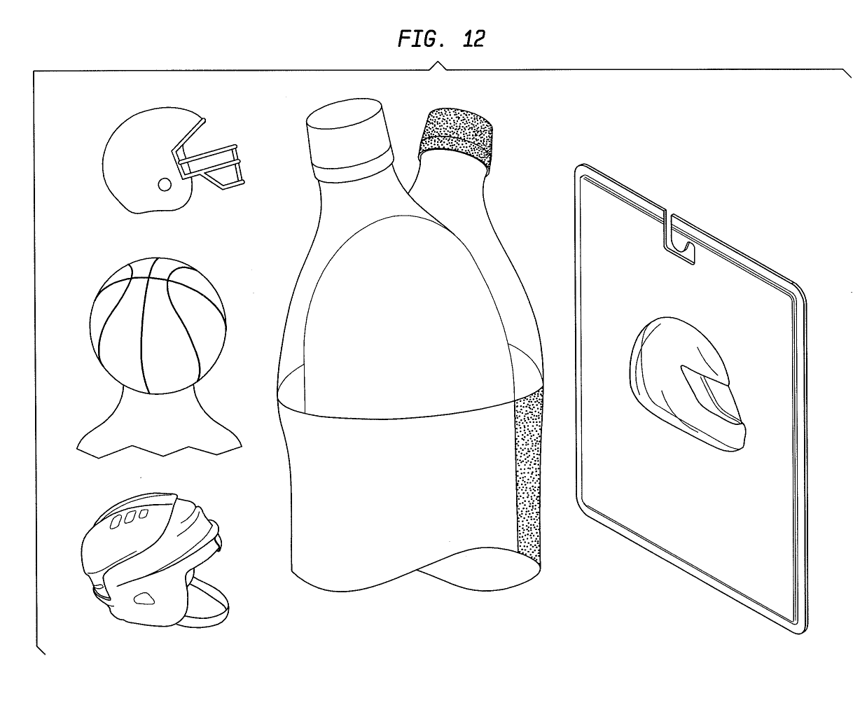

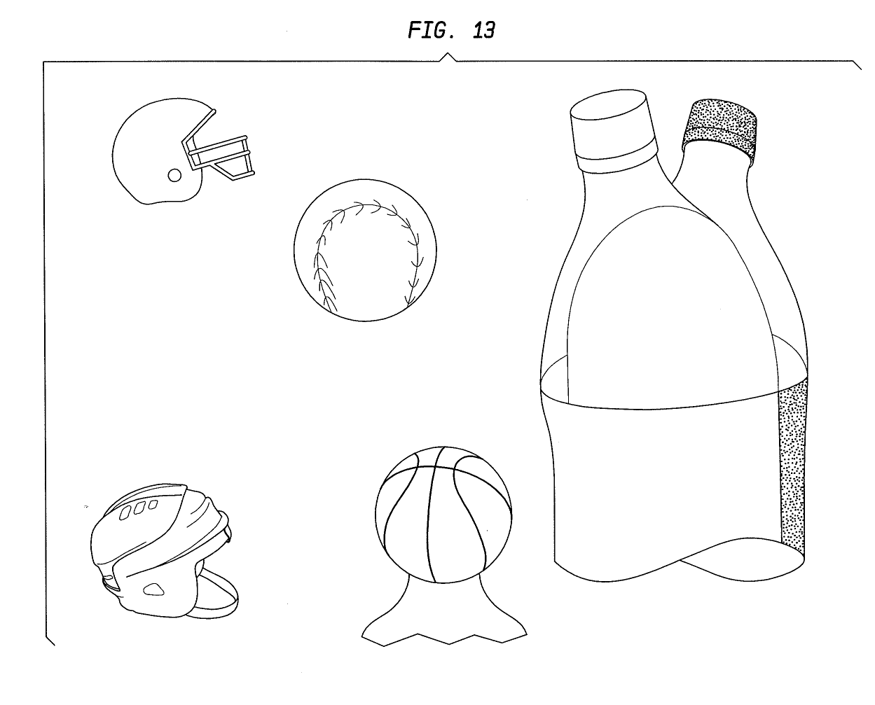

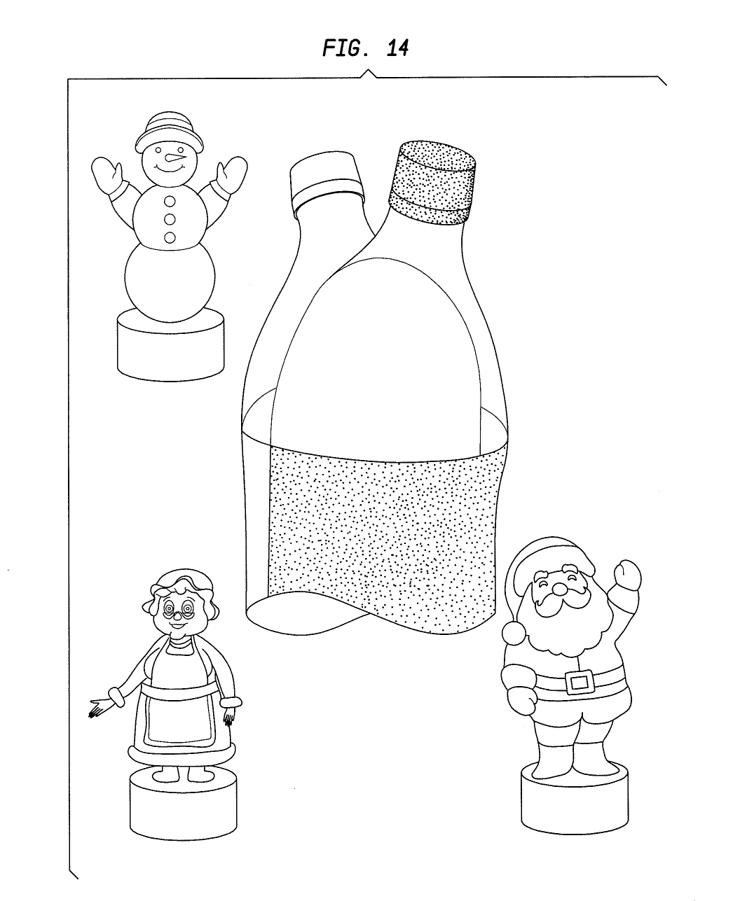

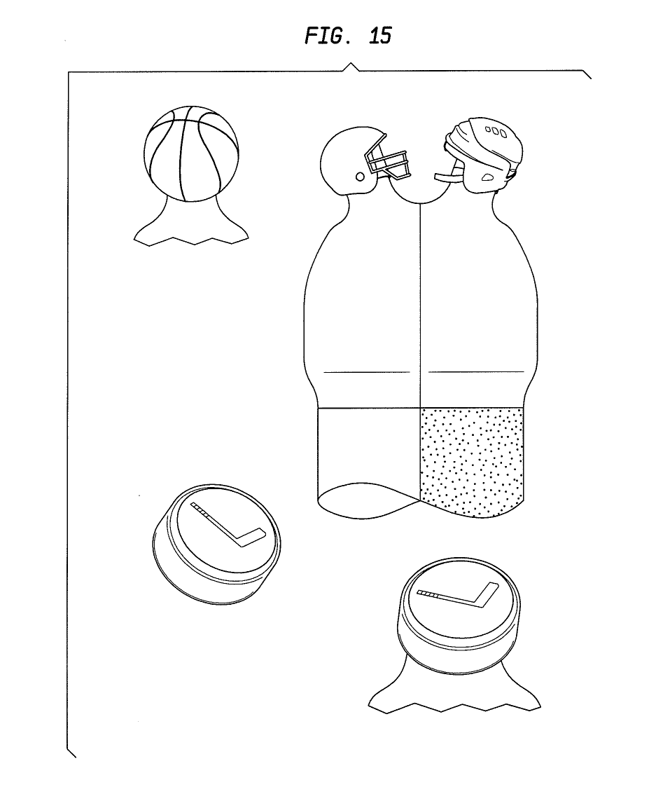

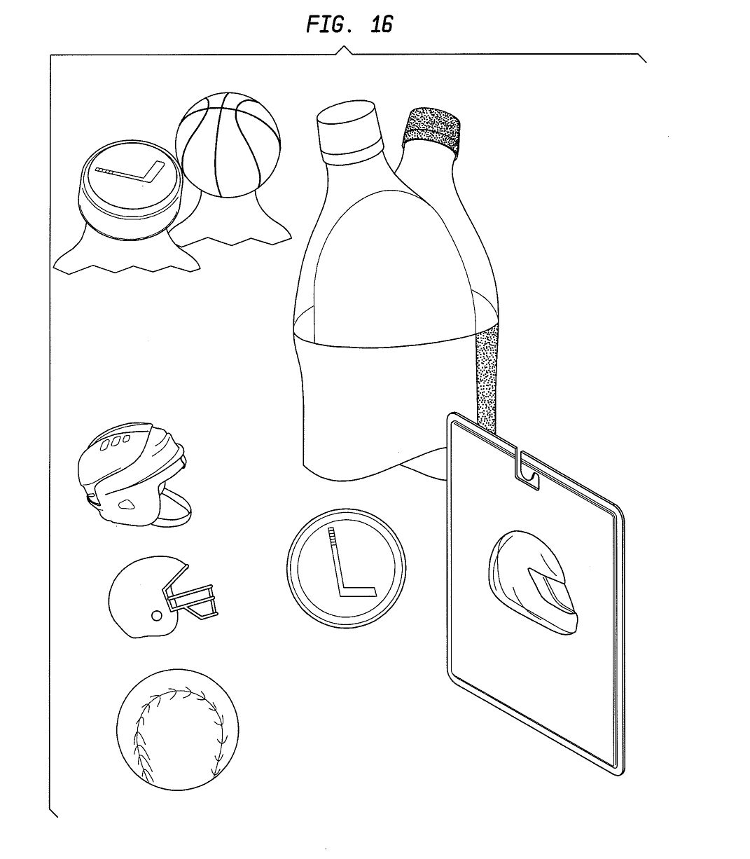

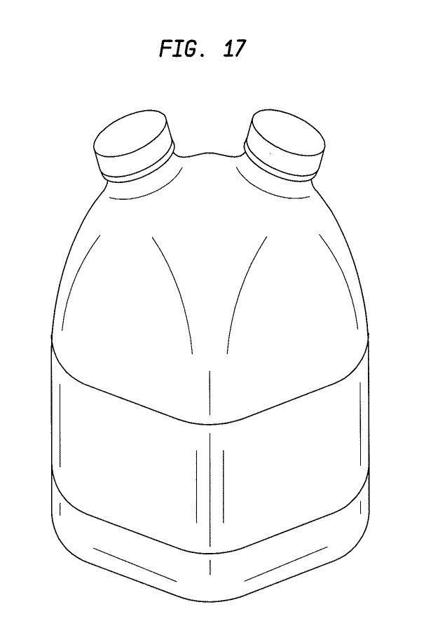

FIGS. 5-17 are photographs of various embodiments and uses of the present invention. These photographs show several, but not all, of the aforementioned inventive features.

Another embodiment of the invention includes caps for the beverage containers, wherein said caps are shaped for promotional purposes, such as sports memorabilia, fictional characters, animals, etc. In one embodiment of this invention, plastic caps are molded to be shaped like football, baseball, hockey or racing headwear. In another embodiment, plastic caps are molded to be shaped like footballs, baseballs, basketballs, or hockey pucks. The caps may include emblems from professional football, baseball, or hockey teams, or NASCAR drivers. The caps may also include emblems from various sports leagues, such as the National Football League, the National Hockey League, or NASCAR. For example, for the two teams in a football super bowl or baseball world series, the caps for the spouts of the two sections could be in the form of or include helmets or hats that are replicas of the helmets or hats use by the two teams. These could become collector items.

In a preferred embodiment of the invention, regular or standard style caps are used, such as conventional screw caps, to reduce costs. In other embodiments, promotional type caps, such as those discussed above, could be used.

In various embodiments, glass and other materials may be used for the containers as well.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A beverage container comprising two or more compartments, each compartment divided from the others so that a beverage in one compartment does not contact a beverage in any other compartment, each compartment having its own spout.

2. The beverage container according to claim 1, further comprising two or more caps, each cap configured and positioned for attachment to one of the spouts, thereby removably sealing the compartment associated with the spout to which the cap is attached.

3. The beverage container according to claim 2, wherein the caps and spouts are threaded so that each cap can be mated onto one of the spouts by threading to removably seal the compartment associated with the spout.

4. The beverage container according to claim 2, wherein each cap is shaped to represent a different particular identifiable entity.

5. The beverage container according to claim 4, wherein the identifiable entity is one of a sports team insignia, a sports team mascot, a sports team icon, a fictional character, or an animal.

6. The beverage container according to claim 1, wherein the container is in the general shape of a plastic two-liter soda bottle.

7. The beverage container according to claim 1, wherein the container is in the general shape of a plastic one-gallon milk bottle.

8. The beverage container according to claim 1, wherein the container is in the general shape of a cardboard half-gallon milk container.

9. A beverage container comprising two compartments, each compartment divided from the other so that a beverage in one compartment does not contact a beverage in the other compartment, the compartments joined together to form a single container, each compartment associated with its own spout, the spouts each located on an upper portion of the container aligned at an angle from a line centrally bisecting the container from top to bottom.

10. The beverage container according to claim 9, wherein the angle is 30 degrees.

11. The beverage container according to claim 9, wherein the angle is 60 degrees.

12. A method of producing a beverage container having two compartments, each compartment divided from the other so that a beverage in one compartment does not contact a beverage in the other compartment, the method comprising:
forming a beverage container having two compartments, each compartment having a planar section;
joining the two compartments along the planar section of each; and,
providing a spout for each of the compartments.

13. The method of producing a beverage container in accordance with claim 12, further comprising:
forming a spiral thread on each spout; and,
forming two caps, each cap comprising a spiral thread mating to the spiral thread on each spout.

14. A food container comprising two or more compartments, each compartment divided from the others so that the contents of one compartment does not contact the contents of any other compartment, each compartment having an opening.

15. The food container according to claim 14, further comprising a two or more caps, each cap configured and positioned for attachment to one of the openings, thereby removably sealing the compartment associated with the opening to which the cap is attached.

16. The food container according to claim 15, wherein openings further each comprise a threaded spout, and the caps are threaded so that each cap can be mated onto one of the spouts by threading to removably seal the compartment associated with the spout.

17. The food container according to claim 15, wherein each cap is shaped to represent a different particular identifiable entity.

18. The food container according to claim 17, wherein the identifiable entity is one of a sports team insignia, a sports team mascot, a sports team icon, a fictional character, or an animal.

19. A beverage container comprising:
two compartments, each compartment divided from the other so that a beverage in one compartment does not contact a beverage in the other compartment;
each compartment having its own spout;
two caps, each cap configured and positioned for attachment to one of the spouts, thereby removably sealing the compartment associated with the spout to which the cap is attached;
wherein the caps and spouts are threaded so that each cap can be mated onto one of the spouts by threading to removably seal the compartment associated with the spout.

20. The beverage container according to claim 19, wherein each cap is shaped to represent a different entity, the entity selected from the group including a sports team insignia, a sports team mascot, a sports team icon, a fictional character, and an animal.
